(19) United States
(12) Patent Application Publication
(10) Pub. No.: US 2026/0086693 A1
(43) Pub. Date: Mar. 26, 2026

(54) PRESENTING USER INTERFACES FOR LATENCY MITIGATION IN A THREE-DIMENSIONAL ENVIRONMENT

(71) Applicant: Apple Inc., Cupertino, CA (US)

(72) Inventor: Matthew L. STERN, Hermosa Beach, CA (US)

(21) Appl. No.: 19/318,015

(22) Filed: Sep. 3, 2025

Related U.S. Application Data
(60) Provisional application No. 63/699,093, filed on Sep. 25, 2024.

(51) Int. Cl. G06F 3/04815; G06F 3/01; G06T 13/20

(52) U.S. Cl. CPC G06F 3/04815; G06F 3/011; G06T 13/20

(57) ABSTRACT

User interfaces can be presented to mitigate latency in a three-dimensional environment. In some examples, while the first electronic device is presenting a first environment of the first electronic device and a second environment of the second electronic device, the first electronic device detects, a first input that includes movement of a portion of a user of the first electronic device from a first location to a second location relative to the first environment. In some examples, in response to detecting the first input, the first electronic device transmits data to the second electronic device that causes the second electronic device to move a portion of the second electronic device from a first location to a second location in the second environment of the second electronic device based on the first input.

### CROSS REFERENCE TO RELATED APPLICATIONS

This application claims the benefit of U.S. Provisional Application No. 63/699,093, filed Sep. 25, 2024, the content of which is herein incorporated by reference in its entirety for all purposes.

### FIELD OF THE DISCLOSURE

This relates generally to systems and methods of presenting user interfaces for latency mitigation in a three-dimensional environment.

### BACKGROUND OF THE DISCLOSURE

Some computer graphical environments provide two-dimensional and/or three-dimensional environments where at least some objects displayed for a user's viewing are virtual and generated by a computer. In some examples, the objects include a representation of an object in a different environment than the user.

### SUMMARY OF THE DISCLOSURE

Users may experience latency between an action and a corresponding response or output by a mechanical (e.g., robotic) system. Thus, in some examples, the electronic device applies one or more visual treatments to mitigate the latency between user movement and mechanical movement. Some examples of the disclosure are directed to systems and methods for presenting user interfaces for latency mitigation in a three-dimensional environment. In some examples, a first electronic device is in communication with one or more displays, one or more input devices, and a second electronic device. In some examples, while the first electronic device is presenting a first environment of the first electronic device and one or more representations of one or more objects of a second environment (e.g., one of the one or more objects corresponds to a portion of the second electronic device) of the second electronic device, the first electronic device detects, via the one or more input devices, a first input that includes movement of a portion of a user of the first electronic device from a first location to a second location relative to the first environment. In some examples, in response to detecting the first input, the first electronic device transmits data to the second electronic device that causes the second electronic device to move the portion of the second electronic device from a first location to a second location in the second environment of the second electronic device based on the first input, and presents, via the one or more displays, the representation of the object corresponding to the portion of the second electronic device at a third location in the first environment, wherein the representation of the object corresponding to the portion of the second electronic device has a first visual treatment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIG. 3A illustrates a schematic diagram in which an electronic device is in communication with a mechanical device 324 according to some examples of the disclosure.

FIGS. 3B-3L illustrate examples of presenting user interfaces for latency mitigation in the three-dimensional environment according to some examples of the disclosure.

FIG. 4 illustrates a flow diagram illustrating an example process for presenting user interfaces for latency mitigation in the three-dimensional environment according to some examples of the disclosure.

### DETAILED DESCRIPTION

Some examples of the disclosure are directed to systems and methods for presenting user interfaces for latency mitigation in a three-dimensional environment. In some examples, a first electronic device is in communication with one or more displays, one or more input devices, and a second electronic device. In some examples, while the first electronic device is presenting a first environment of the first electronic device and one or more representations of one or more objects of a second environment (e.g., one of the one or more objects corresponds to a portion of the second electronic device) of the second electronic device, the first electronic device detects, via the one or more input devices, a first input that includes movement of a portion of a user of the first electronic device from a first location to a second location relative to the first environment. In some examples, in response to detecting the first input, the first electronic device transmits data to the second electronic device that causes the second electronic device to move the portion of the second electronic device from a first location to a second location in the second environment of the second electronic device based on the first input, and presents, via the one or more displays, the representation of the object corresponding to the portion of the second electronic device at a third location in the first environment, wherein the representation of the object corresponding to the portion of the second electronic device has a first visual treatment.

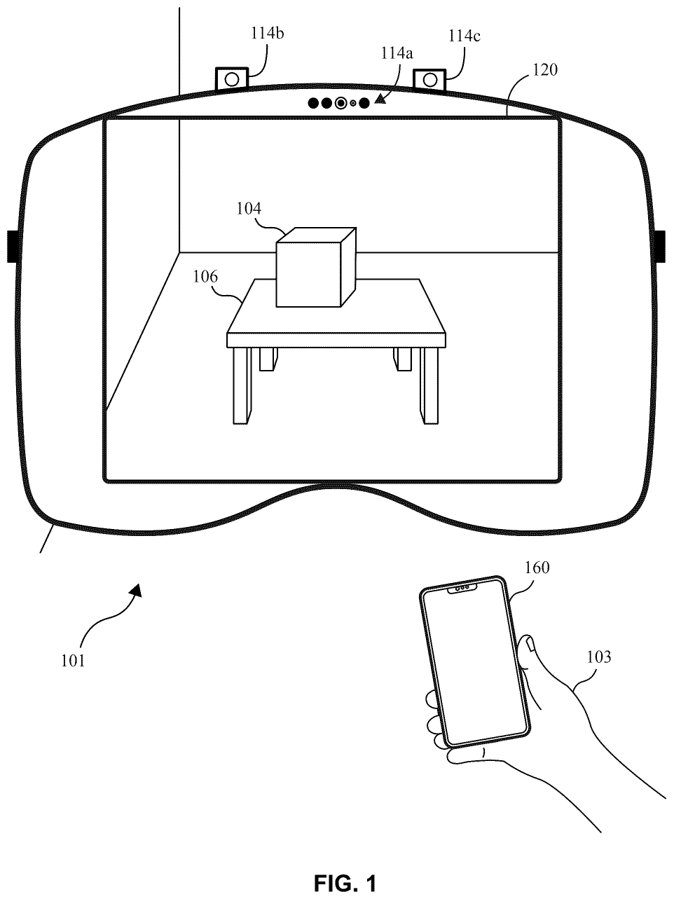

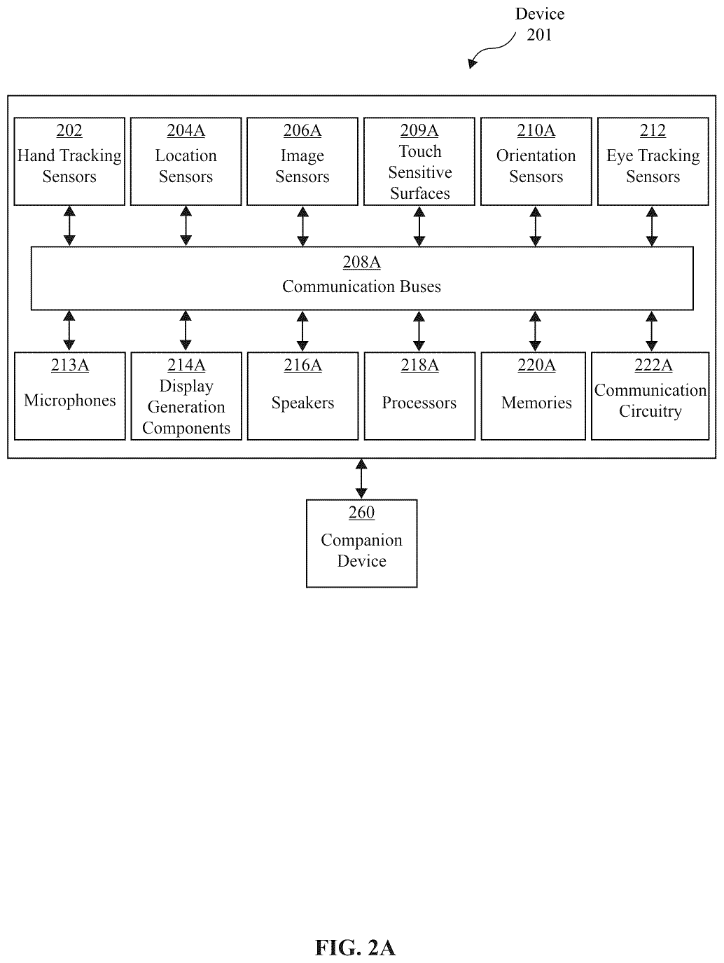

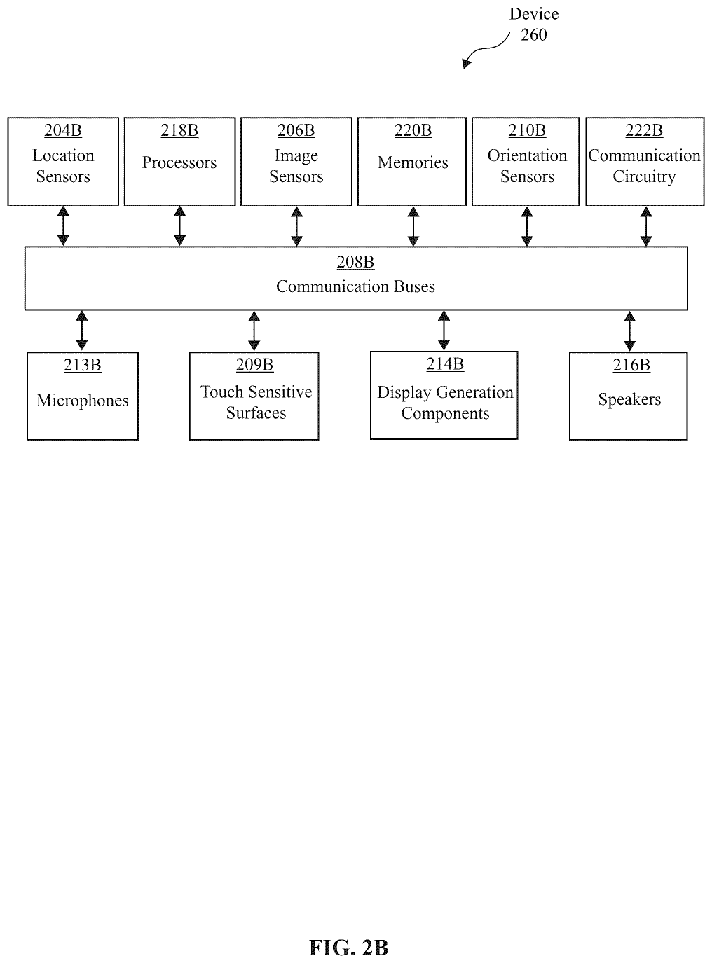

FIG. 1 illustrates an electronic device 101 presenting a three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIGS. 2A and 2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

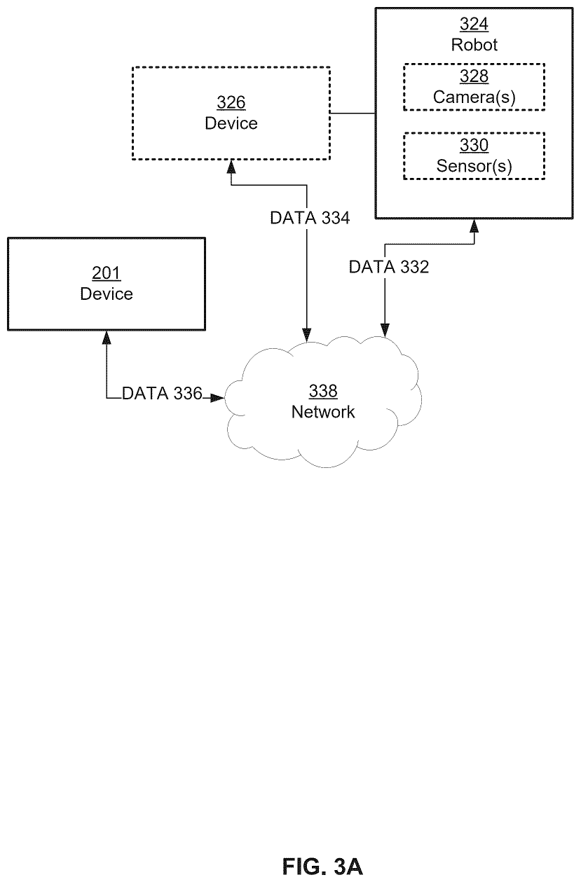

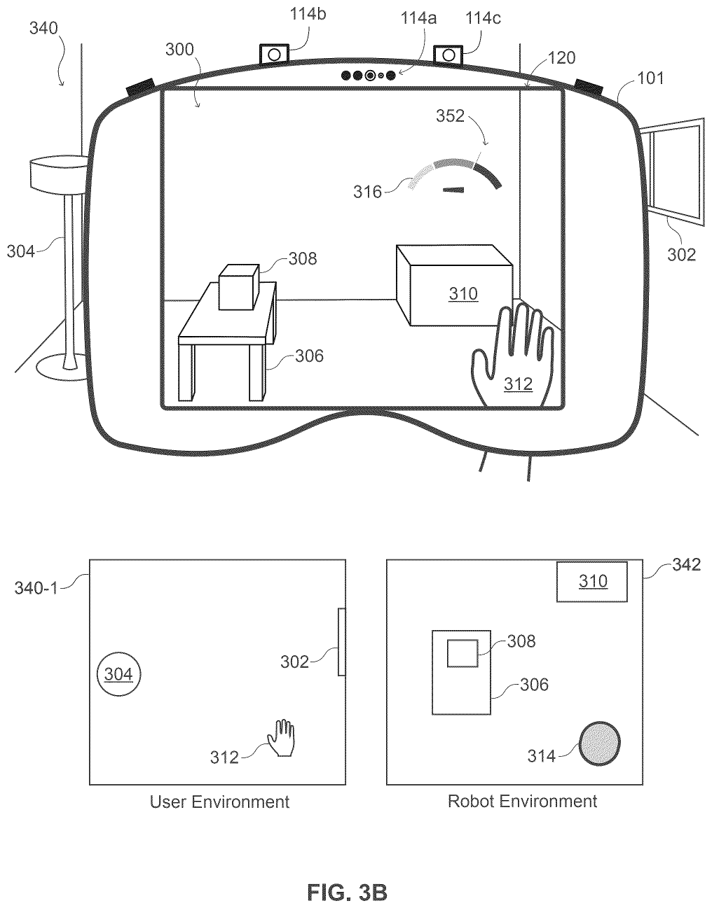

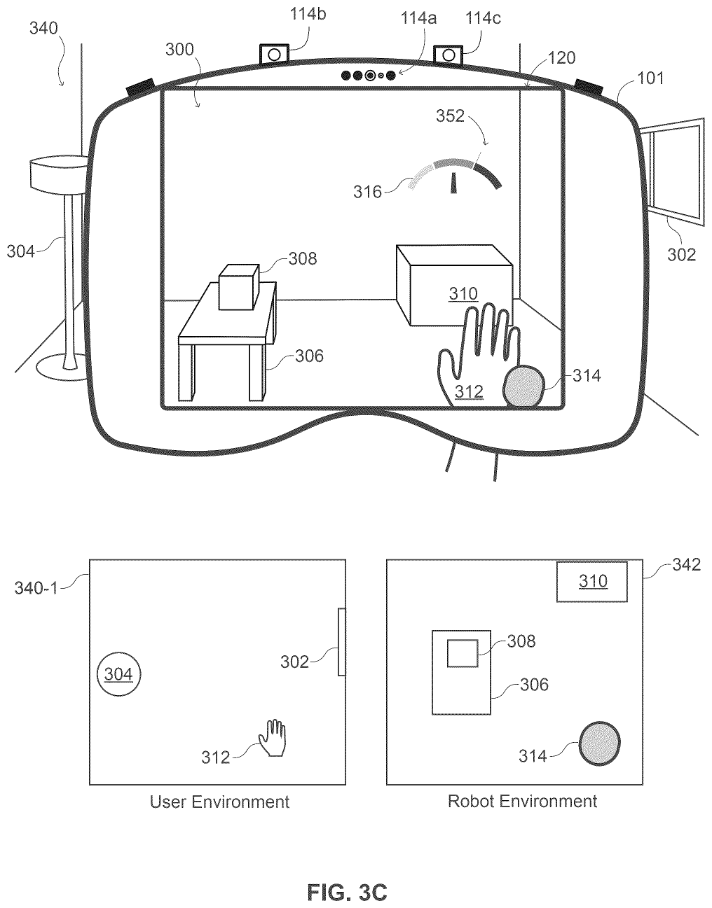

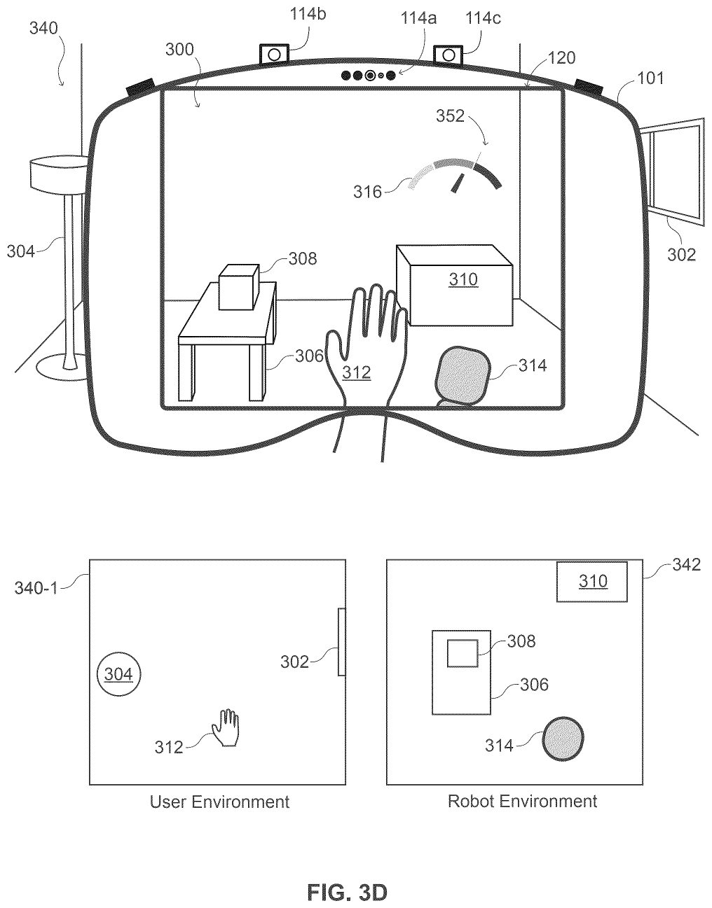

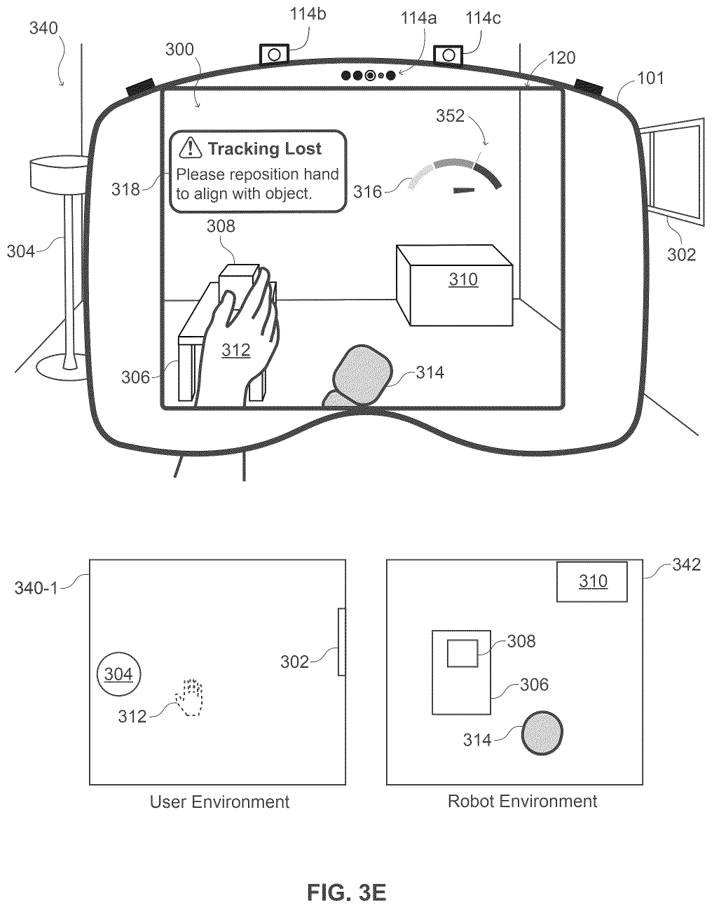

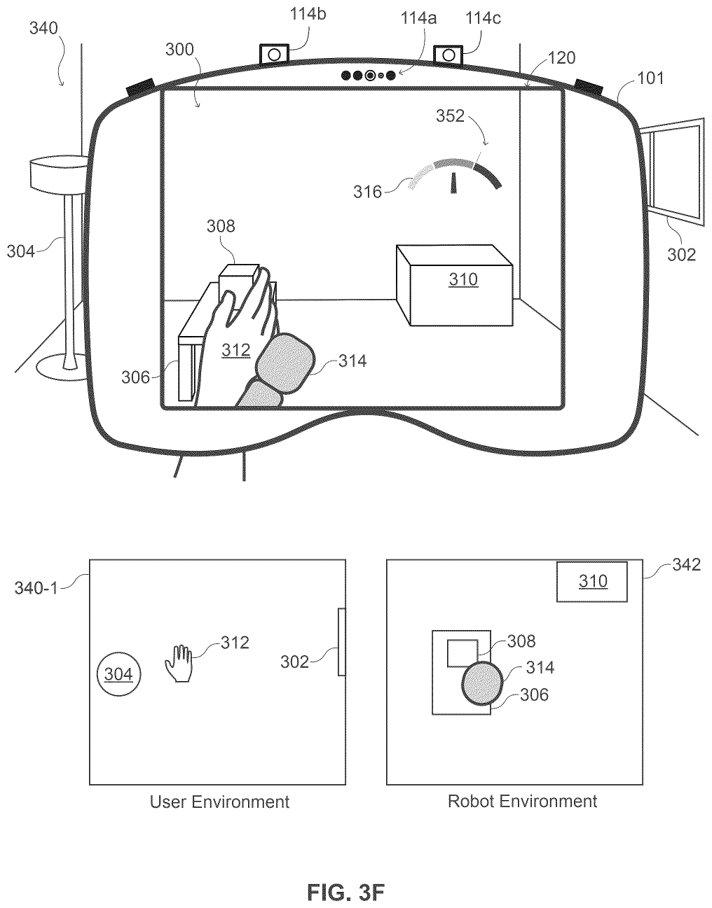

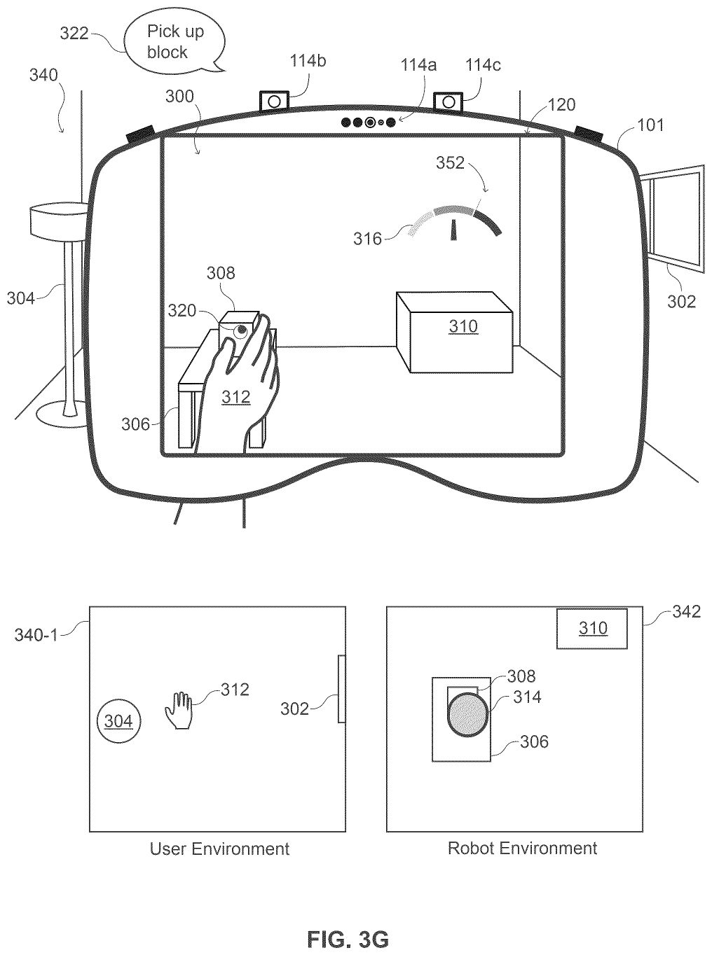

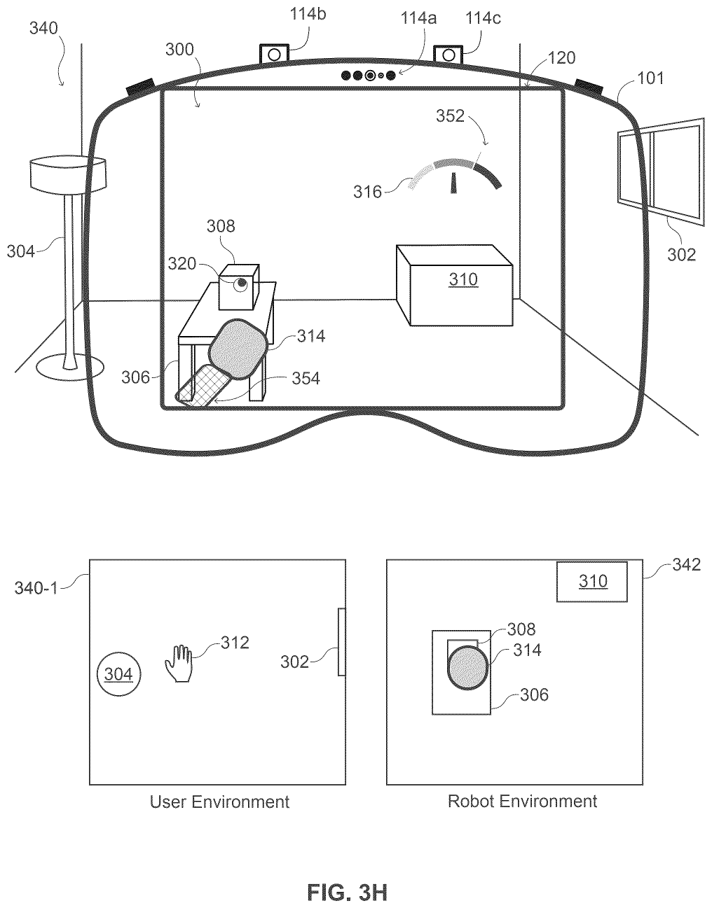

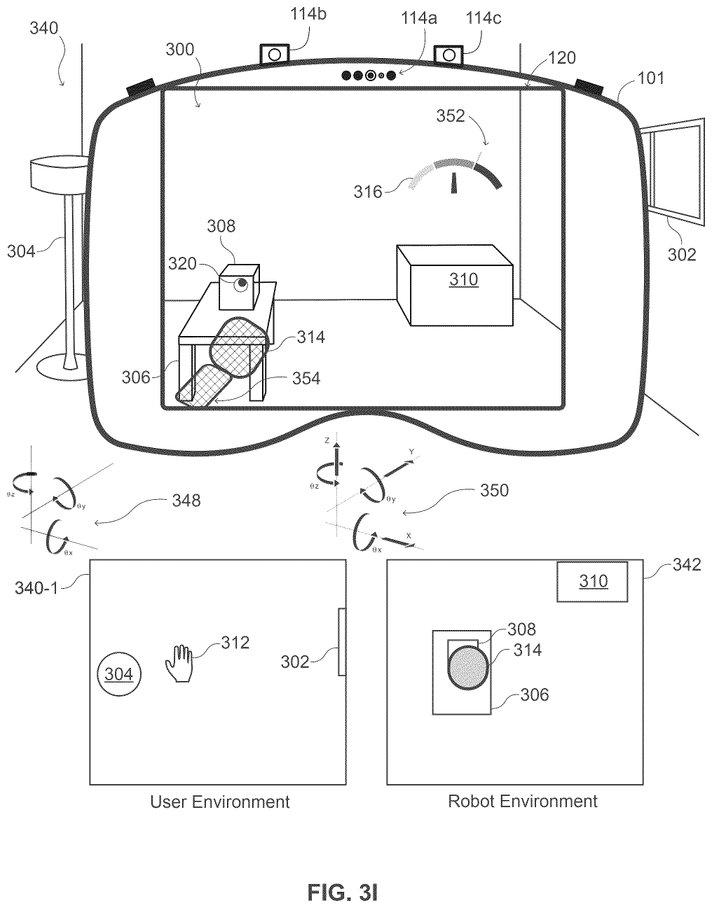

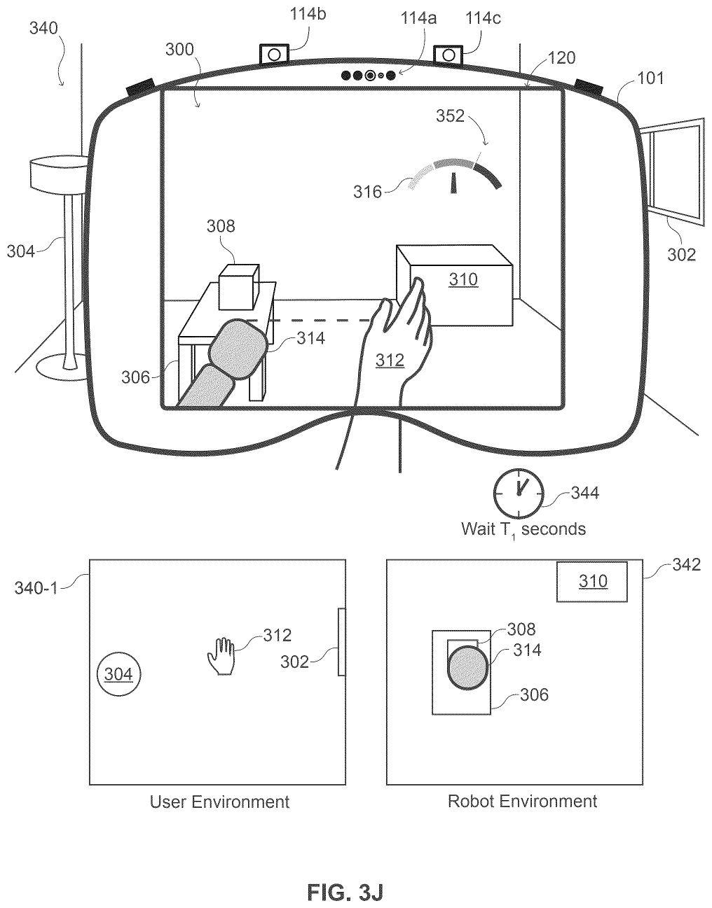

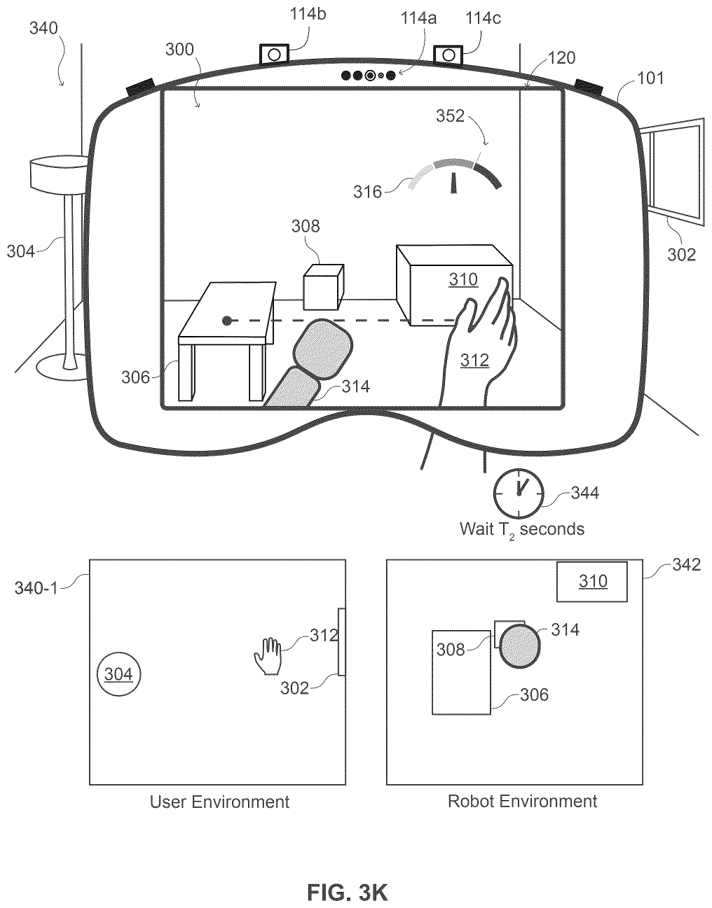

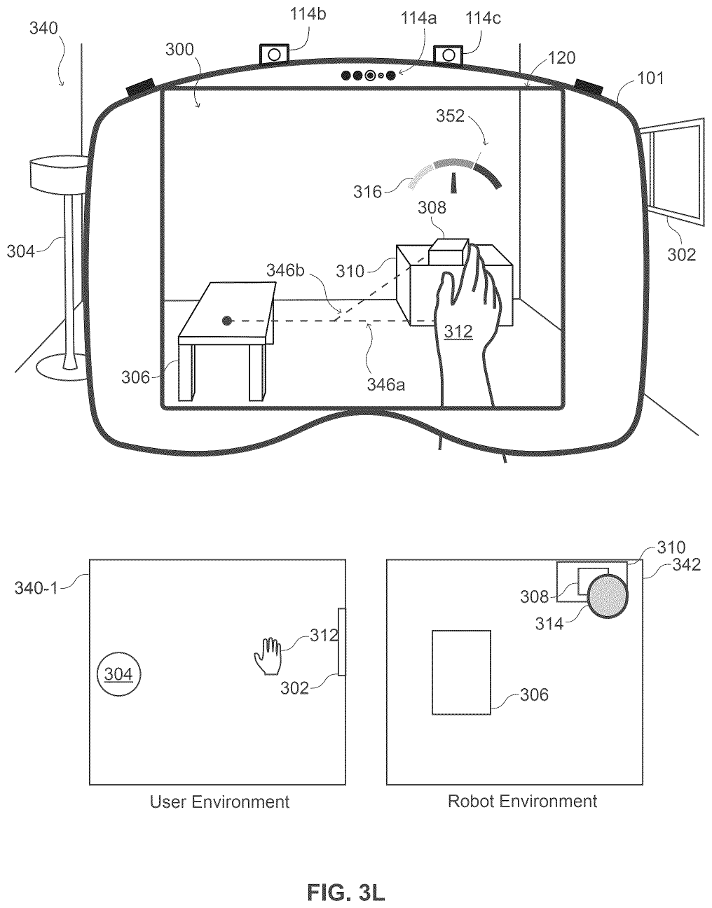

Attention is now directed towards interactions among one or more electronic devices 201 and/or 326 (e.g., electronic device 101) and a mechanical device 324 (e.g., a robot or other electronically controlled mechanical device) in FIG. 3A. FIG. 3A illustrates a schematic diagram in which an electronic device 201 is in communication with a mechanical device 324 in order to remotely control the mechanical device 324 to perform one or more operations as will be described in more detail below. In some examples, electronic device 201 is analogous to (e.g., corresponds to) and/or includes one or more characteristics of the electronic device 101 in FIG. 1. In some examples, electronic device 201 is analogous to (e.g., corresponds to) and/or includes one or more characteristics of the electronic device 201 in FIG. 2. In some examples, the electronic device 201 is in communication with, via communication circuitry 222, the mechanical device 324 via network 338. In some examples, network 338 includes the Internet, intranets, a wired network and/or a wireless network, cellular networks and wireless local area networks (LANs), near-field communication (NFC) and/or short-range communication, such as Bluetooth®. In some examples, electronic device 201 and the mechanical device 324 are not located in a same area or region. For example, the electronic device 201 is optionally located a predetermined distance (e.g., 50, 100, 500, 1000, 5000, or 10000 kilometers) away from the mechanical device 324. In some examples, the electronic device 201 and the mechanical device 324 are located in a same area, such that the electronic device is within the predetermined distance of the mechanical device 324.

In some examples, the mechanical device 324 includes one or more mechanical elements (e.g., robotic arms) configured and/or controlled by the electronic device 201 to manipulate (e.g., move and/or transform) a physical object in an environment of the mechanical device 324 as will described in more detail below and/or illustrated with reference to FIGS. 3B-3L. In some examples, the mechanical device 324 includes one or more camera(s) 328 and one or more sensor(s) 330. In some examples, the one or more camera(s) 328 monoscopically or stereoscopically capture images of the field of view of the mechanical device 324. In some examples, the captured images are presented to a user of the electronic device 201 via one or more displays (e.g., display 120 of FIG. 1). In some examples, movements of the mechanical device 324 are captured via the one or more sensor(s) 330 so as to correlate with movements of the user of the electronic device 201 as described in more detail below. Additionally or alternatively, the mechanical device 324 is optionally equipped with an electronic device 326 that is optionally analogous to and/or includes one or more characteristics of the electronic device 101 in FIG. 1. For example, the electronic device 326 is optionally worn by the mechanical device 324.

In FIG. 3A, data 332 is transmitted between the mechanical device 324 and the electronic device 201 via the network 338. In some examples, the data 332 includes images captured by the one or more camera(s) and/or the electronic device 326 of the physical environment of the mechanical device 324. In some examples, the data 332 includes metadata that describes and/or includes information about the captured images. In some examples, the data 332 includes location and/or pose information of the mechanical device 324 obtained by the one or more sensor(s) 330 and/or the electronic device 326. In some examples, the data 332 includes instructions provided and transmitted by electronic device 201 (e.g., instructions to move a physical object) to the mechanical device 324 as will be described in more detail below. In some examples, data 334 and data 336 include one or more of the same characteristics of data 332. In some examples, data 334 and/or data 336 include additional data, such as location and pose information of the electronic device 201 and electronic device 326, respectively.

In some examples, the first electronic device 101 determines that movement associated with mechanical device 324 is based on a six degree of freedom position and orientation of the mechanical device 324. Thus, in some examples, a respective degree of constraint on the movement of the mechanical device 324b including hand and/or arm movement of the mechanical device 324b allows for six degrees of movement of the mechanical device 324. In some examples, the six degrees of freedom position and orientation include rotation of the mechanical device 324 with respect to the x-axis, rotation of the mechanical device 324 with respect to the y-axis, rotation of the mechanical device 324 with respect to the z-axis, translation of the mechanical device 324 with respect to the x-axis, translation of mechanical device 324 with respect to the y-axis, and translation of the mechanical device 324 with respect to the z-axis. In some examples, in accordance with a determination that the movement associated with mechanical device 324 is based on a six degree of freedom position and orientation of the mechanical device 324, the first electronic device 101 presents a representation of the mechanical device 324 (e.g., described in more detail below) that is based on the six degree of freedom position and orientation of the second electronic device (e.g., device 326). Thus, presenting the representation of the mechanical device 324 based on the six degree of freedom position and orientation optionally provides more precise control of the movement of the mechanical device 324.

In some examples, the first electronic device 101 determines that movement associated with mechanical device 324 is based on a three degree of freedom position and orientation of the mechanical device 324. In some examples, in accordance with a determination that the movement associated with mechanical device 324 is based on a three degree of freedom position and orientation of the mechanical device 324, the first electronic device 101 presents a representation of the mechanical device 324 (e.g., described in more detail below) that is based on a translation between the three degree of freedom position and orientation of the mechanical device 324 and the six degree of freedom position and orientation of mechanical device 324. For example, the electronic device 101 is configured to perform six degree of freedom tracking of the mechanical device 324 based on one or more positional information provided by data 332 (or, optionally, by data 334), such as depth information and/or rotational movement information, thereby, extending the six degree of freedom tracking to three degree of freedom without the need for additional sensors in the mechanical device 324.

FIGS. 3B-3L illustrate examples of presenting one or more visual treatments in accordance with some examples of the disclosure. FIG. 3B illustrates an electronic device 101 (e.g., electronic device 201 of FIG. 2 and FIG. 3A) presenting a computer-generated environment 300 (e.g., an extended reality (XR) environment, a three-dimensional environment, etc.) according to some examples of the disclosure. The computer-generated environment 300 is visible from a viewpoint of a user of the electronic device 101 illustrated in the overhead view 340-1 (e.g., facing a back wall and in-between two walls of the physical environment in which electronic device 101 is located). In some examples, electronic device 101 is a hand-held or mobile device, such as a tablet computer, laptop computer, smartphone, a wearable device, or head-mounted display. Examples of electronic device 101 are described above with reference to the architecture block diagram of FIG. 2. As shown in FIG. 3B, electronic device 101, lamp 304 and window 302 are located in the physical environment 340. In some examples, electronic device 101 may be configured to capture areas of physical environment 340 including lamp 304 and window 302.

In some examples, the viewpoint of the user of the electronic device 101 determines what content is visible in a viewport (e.g., a view of the three-dimensional environment visible to the user via one or more displays or a pair of display modules that provide stereoscopic content to different eyes of the same user). In some examples, the (virtual) viewport has a viewport boundary that defines an extent of the three-dimensional environment that is visible to the user via the one or more displays (e.g., display 120 in FIGS. 3B-3L). In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head-mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head-mounted device, a viewpoint is typically based on a location, a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include one or more displays with video-passthrough (or, optionally, referred to as virtual-passthrough), portions of the physical environment that are visible (e.g., displayed, and/or projected) via the one or more displays are based on a field of view of one or more cameras in communication with the one or more displays which typically move with the one or more displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For the one or more displays with optical-passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head-mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

As shown in FIG. 3B, in some examples, in response to an event (e.g., described in more detail below), the electronic device 101 is configured to display, via display 120, a computer-generated environment 300 that includes a remote view into an environment of a physical location (e.g., physical environment 342 of the mechanical device 324), different from the environment 340 of the electronic device 101. In some examples, the remote view of the physical environment 342 is a real-time video feed or a simulated scene (e.g., a virtual rendering of the physical environment 342) that includes one or more physical objects (e.g., block 308, table 306, and/or container 310) of the physical environment 342 visible in the physical environment 340 of the electronic device 101 via display 120. For example, as shown in an overhead view of physical environment 342 in FIG. 3B, the real-time video feed including real-time images is provided from a viewpoint of the one or more camera(s) 328 of mechanical device 324 (or, optionally, the image sensors (e.g., sensors 114a through 114c) of device 326 worn by the mechanical device 324).

In some examples, the computer-generated environment 300 includes one or more virtual objects overlaid on the real-time images from the one or more camera(s) 328. In some examples, the one or more virtual objects (e.g., user interfaces, user interface elements, and/or representations) are not present in the physical environment 340-1 and 342, but are displayed in the computer-generated environment 300 as described in more detail below. It should be understood that one or more virtual objects described herein are optionally representative objects and one or more different objects (e.g., of various dimensionality such as two-dimensional or three-dimensional objects) can be included and rendered in the computer-generated environment 300.

In some examples, the electronic device 101 mitigates a latency between capturing an action performed by the user of the electronic device 101 (e.g., movement of a portion of the user, such as one or more arms, hands, fingers, and/or legs) and displaying the action being performed by the mechanical device 324 (e.g., movement of one or more mechanical elements, such as robotic arms, hands, fingers, and/or legs). For example, in response to the electronic device 101 detecting an event for controlling the mechanical device 324, the electronic device 101 applies one or more visual treatments to mitigate discomfort caused by latency between user movement and mechanical movement. In some examples, the event for controlling the mechanical device 324 corresponds to the electronic device 101 detecting user input to communicate with and/or control the mechanical device 324 in order for the mechanical device to perform an action, such as move a physical object (e.g., block 308) in the physical environment 342 of the mechanical device 324 or other interaction with the physical object. In some examples, the user input to communicate with the mechanical device 324 includes a voice input from the user corresponding to a request to communicate with the mechanical device. In some examples, the user input to communicate with the mechanical device 324 includes the hand 312 within a viewport of the display 120 as shown in FIG. 3B at a location of the physical environment 340 that corresponds to a predetermined respective location in the computer-generated environment 300. For example, the electronic device 101 optionally displays, via the display 120, a marker at the predetermined respective location in the computer-generated environment 300. In some examples, when the electronic device 101 detects that a location of the hand 312 of the user corresponds to a respective location that is within a predetermined distance (e.g., 0.5, 1, 3, 5, 7, 10, 15, 20, 30, 40, or 50 centimeters) from the predetermined respective location in the computer-generated environment 300, the electronic device 101 establishes a communication session with the mechanical device 324. In another example, the user input to communicate with the mechanical device 324 includes an air gesture (e.g., as described above) while the gaze of the user of the electronic device 101 is directed to a user interface element that, when selected, causes the electronic device 101 to connect (e.g., establish a communication session) with the mechanical device 324. In some examples, the user input to communicate with the mechanical device 324 includes actuation of a physical input device (e.g., digital crown, buttons, joysticks, and/or the like) corresponding to a request to connect with the mechanical device 324.

In some examples, and as will be described in more detail below and illustrated in the figures that follow, establishing the communication session with the mechanical device 324 includes remotely controlling the mechanical element 314 to move block 308 from a first location (e.g., on top of table 306) to a second location (e.g., within container 310) using the hand 312 of the user. For example, the electronic device 101 optionally displays, via the display 120, a representation of the block 308 (e.g., virtual and/or graphical representation of the block 308) in the computer-generated environment 300. In some examples, in response to and/or while the electronic device 101 detects movement of the hand 312 from the first location to the second location within the physical environment 340 as shown in the overhead view 340-1, the electronic device 101 moves the representation of the block 308 from a first respective location to a second respective location in the computer-generated environment 300, as illustrated and described in the figures that follow. In some examples, moving the representation of the block 308 mimics real-world interaction of the mechanical device 324 moving block 308 from the first location to the second location in the physical environment 342 that is based on the detected movement of the hand 312. In some examples, and as will be described in more detail below, the electronic device 101 moves the representation of the block in a manner and/or applies one or more visual treatments to mitigate user discomfort caused by latency and/or to provide feedback to the user that the mechanical device 324 is responsive to the user's control input(s), which provides more efficient user interaction with the mechanical device 324 (e.g., less overall time spent providing user inputs to control the mechanical device 324), thereby conserving computing resources associated with correcting erroneous input(s) from the user.

In FIG. 3B, displaying the representation of block 308 optionally includes displaying the representation of block 308 with a visual appearance (e.g., size, color, shadow, degree of lighting, and/or other visual effect) that emulates the real-world physical block 308. Additionally or alternatively, in some examples, the electronic device 101 presents the remote view (e.g., video-passthrough of the physical environment 342) such that the real-time video feed including real-time images of the block 308 (or, optionally, including table 306 and/or container 310) is presented via the display 120 and/or is visible via a region of the display 120 corresponding to a respective region in which the real-world block 308 is located in the physical environment 342. In some examples, the electronic device 101 optionally presents, via display 120, a representation of (or, optionally, a video-passthrough of) the table 306 and/or a representation of (or, optionally, a video-passthrough of) the container 310. In some examples, displaying the respective representations (or, optionally, respective video-passthroughs of) the table 306 and/or the container 310 is optionally analogous to and/or includes one or more characteristics of displaying the representation (or, optionally, a video-passthrough of) the block 308 as described herein.

In some examples, and as shown in FIG. 3B, the hand 312 is presented as real-passthrough (or, optionally, referred to as true-passthrough) such that hand 312 is presented via the display 120 and/or is visible via a transparent or translucent region of the display 120 because the electronic device 101 does not obscure/prevent visibility of the hand 312 through the display 120. Additionally or alternatively, hand 312 is optionally presented by the electronic device 101 as a digital representation such as an animated graphical representation of the user's hand emulating the hand's appearance and orientation. In some examples, the electronic device 101 optionally increases or decreases the visibility of the hand 312 and/or optionally ceases to present the hand 312 (or, optionally, replaces the hand 312 with a virtual object) to mitigate latency as described in more detail below.

In FIG. 3B, while the electronic device 101 is in communication with mechanical device 324, the electronic device 101 determines that a location of the hand 312 in the physical environment 340 as shown in overhead view 340-1 corresponds to a respective location of the mechanical element 314 as shown in overhead view of the physical environment 342 of the mechanical device 324. In some examples, in accordance with the determination that the location of the hand 312 corresponds to the respective location of the mechanical element 314, the electronic device 101 ceases to display a representation of the mechanical element 314 (e.g., mechanical element 314 in computer-generated environment 300 in FIG. 3C). Thus, in some examples, ceasing to display the representation of the mechanical element 314 indicates to the user of the electronic device 101 that a location (and, optionally, a pose) of the mechanical element 314 corresponds to (e.g., is in sync with) hand 312. In some examples, in accordance with the determination that the location of the hand 312 corresponds to the respective location of the mechanical element 314, the electronic device 101 presents, via display 120, the representation of the mechanical element 314 overlaid on the hand 312. In some examples, the manner in which the electronic device 101 presents or forgoes presenting the mechanical element 314 in accordance with the determination that the location of the hand 312 corresponds to the respective location of the mechanical element 314 conveys to the user that hand 312 is synchronized with the mechanical element 314. In FIG. 3B, the electronic device 101 also optionally presents, via display 120, an indicator 316 (e.g., virtual indicator) indicative of a speed at which the electronic device 101 detects a movement of the hand 312. In FIG. 3B, the indicator 316 indicates a zero speed (e.g., the electronic device 101 does not detect movement of hand 312). In some examples, when the electronic device 101 detects that movement of the hand 312 does not satisfy one or more criteria, including a movement criterion that is satisfied when the movement of the hand exceeds a predetermined velocity threshold 352 (e.g., 25, 50, 75, 100, 125, 150, or 200 millimeters/second) and/or falls within a range that corresponds to typical hand movements, the electronic device 101 presents, via display 120, a notification (or, optionally, provides an audible notification) that movement of the hand 312 is detected at a speed in which the mechanical device 324 cannot keep up with, resulting in a mismatch (e.g., caused by latency) as described in more detail below.

In some examples, and as will be described in more detail below, the electronic device 101 determines that there may be latency between user movement and mechanical movement. Thus, in some examples, the electronic device applies one or more visual treatments to mitigate the latency between user movement and mechanical movement. For example, in FIG. 3C, the electronic device 101 detects, via one or more input devices (e.g., internal image sensor 114a, external image sensors 114b and 114c and/or other input devices, such as one or more of the components described above with reference to FIG. 2), movement of the hand 312 from a first location in the physical environment 340 as shown in FIG. 3B to a second location in the physical environment 340 as shown in FIG. 3C. In some examples, in response to detecting the movement of the hand 312 from the first location to the second location, the electronic device 101 presents, via the display 120, a representation of (or, optionally, a real-passthrough of) the hand 312 moving from a first respective location in the computer-generated environment 300 to a second respective location in the computer-generated environment 300. In some examples, in response to detecting the movement of the hand 312 from the first location to the second location, and in accordance with the determination that the movement of the hand 312 satisfies the one or more criteria including the movement criterion described above with reference to FIG. 3B, the electronic device 101 transmits data (e.g., data 336 in FIG. 3A) including instructions that cause the mechanical device 324 to move its mechanical element 314 from a first respective location in the physical environment 342 as shown in overhead view of the physical environment 342 in FIG. 3B to a second respective location in the physical environment 342 as shown in overhead view of the physical environment 342 in FIG. 3C. In some examples, the electronic device 101 presents, via the display 120, a representation of the mechanical element 314 at a fifth location in the computer-generated environment 300.

In some examples, the fifth location corresponds to the first respective location in the physical environment 342 as shown in overhead view of the physical environment 342 in FIG. 3B. For example, the first respective location is a starting location of a path of motion for the mechanical device 324. In some examples, the path of motion for the mechanical device 324 starts at the first respective location and ends with a respective destination location that includes block 308 within container 310. In some examples, the path of motion for the mechanical device 324 includes a plurality of respective locations in-between the first respective location and the respective destination location for the mechanical device 324 to move block 308 from table 306 to container 310 as will be described in the figures that follow. In some examples, the fifth location corresponds to the second respective location in the physical environment 342 as shown in overhead view of the physical environment 342 in FIG. 3C. For example, the electronic device 101 presents the representation of the mechanical element 314 at the second respective location giving the visual appearance of trailing behind the hand 312. Thus, in some examples, the first electronic device 101 delays movement of the representation of the mechanical element 314 by an amount relative to movement of the hand 312. In some examples, and in accordance with a determination that movement of the representation of mechanical element 314 is to a sixth location corresponding to a respective portion of the hand 312, the first electronic device 101 optionally ceases to present the representation of the mechanical element 314. In some examples, the electronic device 101 presents the representation of the mechanical element 314 aligned with (or, optionally overlaid on) the hand 312.

In some examples, the representation of the mechanical element 314 is a digital representation such as an animated graphical representation of the mechanical element 314 emulating the mechanical element's appearance and orientation, such as shown in FIG. 3C. In some examples, the electronic device displays the digital representation of the mechanical element 314 with a visual appearance of being at least partially transparent relative to the hand 312 of the user. For example, in accordance with a determination that movement of the representation of mechanical element 314 is to a seventh location that is within a threshold distance (e.g., 0, 1, 2, 3, 5, 10, 15, 20, 25, 30, or 50 cm) of a location of the hand 312 of the user, the first electronic device 101 optionally presents, via the display 120, the representation of the mechanical element 314 having a first amount of transparency (e.g., 50%, 55%, 60%, 65%, 70%, 80%, or 90%). In some examples, in accordance with a determination that the seventh location is further than the threshold distance of the location of the hand 312 of the user, such as, for example, as shown in FIG. 3D, the first electronic device 101 optionally presents the representation of the mechanical element 314 having a second amount of transparency, different from the first amount of transparency. In some examples, the second amount of transparency is less than the first amount of transparency. In some examples, the second amount of transparency is greater than the first amount of transparency.

In some examples, the first electronic device 101 scales the representation of the mechanical element 314 to a size corresponding to a size of the hand 312 of the user as shown in FIG. 3D. For example, the first electronic device 101 initially presents the representation of the mechanical element 314 with a first initial size (e.g., a “true” size of the mechanical element 314) as shown in FIG. 3C. In some examples, the first electronic device 101 presents the representation of the mechanical element 314 with a second size corresponding to size of the hand 312 of the user as shown in FIG. 3D. For example, in FIG. 3D, the representation of the mechanical element 314 is a size larger than the respective size of the representation of the mechanical element 314 in FIG. 3C.

FIG. 3D also illustrates the first electronic device 101 updating speed indicator 316 to indicate a detected increased speed of movement of the hand 312 from a first respective location as shown in FIG. 3C to a second respective location as shown in FIG. 3D. In some examples, the first electronic device 101 determines that the increased speed of movement does not satisfy the one or more the one or more criteria, including the movement criterion that is satisfied when the movement of the hand exceeds the predetermined velocity threshold 352 (e.g., as described above with reference to FIG. 3B). In some examples, in accordance with the determination that the increased speed does not satisfy the movement criterion, the electronic device 101 forgoes presenting, via display 120, a notification (or, optionally, forgoes providing an audible notification) that the detected increased movement of the hand 312 is at a speed with which the mechanical device 324 cannot keep up, resulting in a mismatch (e.g., caused by latency) as will be described in more detail below. In some examples, in accordance with the determination that the increased speed does not satisfy the movement criterion, the electronic device 101 transmits data to the mechanical device 324 that causes the mechanical device 324 to move its mechanical element from a respective third location as shown in FIG. 3D to a respective fourth location corresponding to the second respective location of the hand 312, as shown in FIG. 3D. In some examples, while (and/or, optionally, in response to) transmitting the data to mechanical device 324, the first electronic device 101 presents, via the display 120, the representation of the mechanical element 314 at the respective fourth location as shown in FIG. 3E.

FIG. 3E illustrates presenting a notification 318 via the display 120, in response to detecting that a speed of movement associated with the hand 312 exceeds the predetermined velocity threshold 352 (e.g., as described above with reference to FIG. 3B). For example, in FIG. 3E, the first electronic device 101 detects an increased speed of movement of the hand 312 from the second respective location as shown in FIG. 3D to a third respective location as shown in FIG. 3E. The speed indicator 316 is updated to indicate the detected increased speed of movement of the hand 312 exceeds the predetermined velocity. In some examples, in accordance with a determination that the one or more criteria are satisfied, including the criterion that is satisfied when detecting the movement of the hand 312 is above the predetermined velocity, the electronic device 101 forgoes the transmission of the data until the one or more criteria are not satisfied (e.g., until the electronic device determines that movement of the hand 312 is below the predetermined velocity). In some examples, in accordance with the determination that the increased speed exceeds the predetermined velocity (e.g., satisfies the movement criterion described above with reference to FIG. 3B), the electronic device 101 presents, via display 120, an indication that detecting the movement of the hand 312 is above the predetermined velocity. In some examples, the indication includes a notification 318 as shown in FIG. 3E. In some examples, the notification 318 includes content informing the user that tracking the hand 312 is lost (e.g., not detected). In some examples, the notification 318 includes content instructing the user of the first electronic device to recalibrate (e.g., reposition hand 312 to align with an object). In some examples, the object corresponds to the representation of the mechanical element 314 in FIG. 3E. In some examples, the object is a representation of a target (not illustrated) at a last location at which the hand 312 was detected prior to detecting movement of hand 312 exceeding the predetermined velocity. In some examples, in response to detecting movement of the hand 312 to a location corresponding to a respective location of the representation of the mechanical element 314 (e.g., hand 312 is aligned with the representation of the mechanical element 314), the electronic device 101 resumes tracking movement of the hand 312 as long as the speed of the movement of the hand 312 remains below the predetermined velocity.

FIG. 3F illustrates the electronic device 101 detecting movement of the hand 312 from the second respective location as shown in FIG. 3D to a third respective location as shown in FIG. 3F. In some examples, the first electronic device 101 updates the speed indicator 316 to indicate the detected speed of movement of the hand 312 is below the predetermined velocity. In some examples, in accordance with a determination that the one or more criteria are not satisfied, including the criterion that is satisfied when detecting the movement of the hand 312 is above the predetermined velocity, the electronic device 101 transmits data to the mechanical device 324 that causes the mechanical device 324 to move the mechanical element of the mechanical device 324 from a first respective location as shown in FIG. 3D in the physical environment 342 to a second respective location as shown in FIG. 3F in the physical environment 342. In some examples, the first electronic device 101 presents, via the display 120, the representation of the mechanical element 314 as moving from a first location as shown in FIG. 3D to a second location as shown in FIG. 3F.

In some examples, presenting the representation of the mechanical element 314 at the second location includes presenting the representation of the mechanical element 314 having a level of opacity less than a respective level of opacity associated with presenting the hand 312. In some examples, presenting the representation of the mechanical element 314 with a particular level of opacity provides feedback to the user that, despite some latency, the mechanical device is responsive to the user's movements and that the mechanical element 314 is moving in accordance with the user's movements. Thus, instead of waiting until the mechanical element 314 moves from the first location to the second location in the physical environment 342, the electronic device 101 visually presents the representation of the mechanical element 314 ahead of time to reduce the latency in the mechanical device 324 moving its hand by presenting a preview or, optionally, a projected path of movement of the mechanical element 314. For example, the electronic device 101 is configured to process previous movements of hand 312 to generate “best guess” path of movement information (e.g., estimated projected path of movement) without detecting further movement of hand 312. In other words, the first electronic device 101 is configured to utilize previous movement and/or position data points of hand 312 to generate “best guess” path of movement information according to which the representation of the mechanical element 314 is moved in the three-dimensional environment 300.

In some examples, the electronic device 101 delays moving the representation of the mechanical element 314 as shown in FIG. 3F with the representation of the mechanical element 314 trailing behind a path of movement of the hand 312 to synchronize the representation of the mechanical element 314 with the movement of the mechanical element 314 in the physical environment 342. In some examples, the electronic device 101 delays movement of the presentation of the mechanical element 314 by a predetermined amount of time (e.g., 10, 20, 30, 40, 50, 100, or 200 milliseconds), and irrespective of the current movement of the hand 312. In some examples, and as will be described in more detail below, the delay prevents accidental detecting of user input to control the mechanical device 324.

FIG. 3G illustrates that, in some examples, the first electronic device 101 determines that a location of the mechanical element 314 corresponds to the hand 312, and in accordance with a determination that the location of the mechanical element 314 corresponds to the hand 312, the electronic device 101 ceases to display the representation of the mechanical element 314 (e.g., ceases to display mechanical element 314 in computer-generated environment 300 in FIG. 3G). In some examples, ceasing to display the representation of the mechanical element 314 indicates to the user of the electronic device 101 that the location of the mechanical element 314 corresponds to (e.g., is in sync with) the hand 312. In some examples, prior to transmitting the data instructing the mechanical device 324 to perform an action, the first electronic device 101 optionally detects a gaze-based confirmation input from the user of the first electronic device 101. For example, in FIG. 3G, while the hand 312 is directed to block 308 (or, optionally, while the hand 312 is at a location corresponding to a respective location of block 308), the first electronic device 101 detects movement of the hand 312 corresponding to a request to pick up block 308. In some examples, prior to transmitting the request for mechanical device 324 to pick up block 308, and in accordance with a determination that the request to pick up block 308 includes a gaze-based confirmation input from the user of the first electronic device 101, the electronic device 101 transmits the request for mechanical device 324 to pick up block 308 in the physical environment 342. In some examples, and as shown in FIG. 3G, the gaze-based confirmation input includes gaze 320 directed to the block 308 for a period of time greater than a threshold period of time (e.g., 0.5, 0.7, 0.9, 1, 3, 5, 10, or 30 seconds). In some examples, the period of time starts at a moment when the electronic device 101 detects a direction of the user's gaze 320 directed to block 308. In some examples, the electronic device 101 restarts or ceases tracking the period of time when the electronic device 101 determines that the direction of the user's gaze 320 is directed away from the block 308.

In some examples, prior to transmitting the data instructing the mechanical device 324 to perform the action of picking up block 308, the first electronic device 101 optionally detects a voice confirmation input from the user of the first electronic device 101. For example, and as shown in FIG. 3G, prior to transmitting the request for mechanical device 324 to pick up block 308, the electronic device 101 determines that the request to pick up block 308 includes voice confirmation input 322 from the user of the first electronic device 101. In some examples, in accordance with the determination that the request includes voice confirmation input 322, the electronic device 101 transmits the request for mechanical device 324 to pick up block 308. In some examples, the voice confirmation input 322 includes a voice command specifying the action (e.g., “Pick up block”), as shown in FIG. 3G. In some examples, the electronic device 101 optionally forgoes transmitting the data instructing the mechanical device 324 to perform the action of picking up the block 308 until the electronic device 101 detects the voice confirmation input and/or the gaze-based confirmation input.

In some examples, the first electronic device 101 presents, via the display 120, an indication of the progress of the mechanical device 324 towards performing (or, optionally, completing) the action (e.g., picking up the block 308). For example, in FIG. 3H, the first electronic device 101 optionally presents a filling animation 354 of the representation of the mechanical element 314. In some examples, the rate of the filling animation corresponds to the progress of the movement of the mechanical element 314 toward picking up block 308. For example, in FIG. 3H, the electronic device 101 presents the representation of the mechanical element 314 as being approximately 50% filled corresponding to the progress of the movement of mechanical element 314 picking up block 308 (e.g., mechanical element 314 is halfway complete with the action of picking up block 308) in the physical environment 342.

FIG. 3I illustrates the electronic device 101 presenting the representation of the mechanical element 314 as being 100% filled to visually represent completion of the action of picking up block 308. In some examples, presenting the filling animation 354 of the mechanical element 314 includes presenting a wire frame model of the mechanical element 314 (or, optionally, other outline model of the mechanical element 314).

In some examples, and as described above with reference to FIG. 3A, the mechanical device 324 and the first electronic device 101 (e.g., electronic device 201) operate with six degrees of freedom (e.g., as shown by 350 in FIG. 3I). Thus, in some examples, when the electronic device 101 detects hand 312 manipulating block 308 in up to six degrees of freedom (e.g., as shown by 350), the first electronic device 101 presents, via display 120, the representation of the mechanical element 314 manipulating the block 308 in accordance with the hand 312 manipulating block 308. For example, the first electronic device 101 presents the representation of the mechanical element 314 rotating the block 308 with respect to the x-axis, rotating the block 308 with respect to the y-axis, rotating the block 308 with respect to the z-axis, translating the block 308 with respect to the x-axis, translating the block 308 with respect to the y-axis, and/or translating the block 308 with respect to the z-axis based on the input from the hand 312. In some examples, first electronic device 101 presents the representation of the mechanical element 314 manipulating block 308 according to the movement of the right hand 312. For example, based on the first electronic device 101 detecting hand 312 moving to the right and rotating clockwise relative to the direction of movement, the electronic device 101 optionally presents the representation of the mechanical element 314 moving to the right and rotating clockwise relative to the direction of movement.

In some examples, and as described above with reference to FIG. 3A, the mechanical device 324 operates with three degrees of freedom (e.g., as shown by 348 in FIG. 3I) and the first electronic device 101 operates with six degrees of freedom (e.g., as shown by 350). Thus, when the electronic device 101 detects hand 312 manipulating block 308 in up to six degrees of freedom (e.g., as shown by 350), the first electronic device 101, presents via display 120, the representation of the mechanical element 314 rotating the block 308 with respect to the x-axis, rotating the block 308 with respect to the y-axis, and/or rotating the block 308 with respect to the z-axis. In some examples, rotating the block 308 does not include translating the block 308 (e.g., with respect to the x-axis, y-axis, and/or z-axis). In some examples, rotating the block 308 includes a combination of rotation and translation of the block 308 (e.g., a translation between the three degree of freedom position and orientation of the mechanical device 324 and the six degree of freedom position and orientation of the first electronic device 101). For example, in accordance with a determination that manipulating the block 308 includes detecting hand 312 moving to the right and rotating clockwise relative to the direction of movement, the first electronic device 101 optionally presents the representation of the mechanical element 314 moving the block 308 to the right (or, optionally, additionally rotating clockwise relative to the direction of movement).

In some examples, the first electronic device 101 optionally transmits data including movement of the mechanical element 314 from a first respective location to a second respective location in response to detecting movement of hand 312 from a first location to a second location after a time delay. In some examples, the first electronic device 101 is configured to delay transmitting data to the mechanical device 324 after a time delay so as to avoid erroneously instructing the mechanical device 324 to perform an action in accordance with accidental or unintentional movements of the hand 312. For example, after determining that the mechanical device 324 has performed the action of picking up block 308 as described above with reference to FIG. 3I, the first electronic device 101 detects movement of hand 312 from a first location as shown in FIG. 3I to a second location as shown in FIG. 3J. In some examples, the electronic device 101 transmits the data including an action for mechanical device 324 to move the mechanical element 314 from a first respective location corresponding to the first location of hand 312 as shown in FIG. 3I to a second respective location corresponding to the second location of hand 312 in FIG. 3J after a time delay 344 (e.g., 0.3, 0.5, 1, 3, 5, 7, 10, 15, 20, or 30 seconds) without detecting further input from hand 312. In some examples, in accordance with a determination that no further input from hand 312 (or, optionally, input from the user of the first electronic device 101) is detected, the first electronic device 101 transmits the data to the mechanical device 324 after the time delay 344.

In some examples, while transmitting the data to the mechanical device 324, the first electronic device 101 detects a second input that includes second movement of the hand from the second location as shown in FIG. 3J to a third location as shown in FIG. 3K. In some examples, in response to (and/or, optionally, while) detecting the second input, the electronic device 101 determines that the second movement is detected within a threshold amount of time or time delay of transmitting the data to the second electronic device (e.g., device 326 in FIG. 3A), and in accordance with the determination that the second movement is detected within the threshold amount of time or time delay 344 (e.g., 0.5, 1, 3, 5, 7, 10, 15, 20, 30, 40, 50, or 60 seconds), the first electronic device 101 transmits second data to the mechanical device 324 that causes the mechanical device 324 to move the mechanical element 314 from the second respective location corresponding to the second location of the hand 312 as shown in FIG. 3J to a third respective location corresponding to the third location of the hand 312 as shown in FIG. 3K. In some examples, the electronic device 101 sets the threshold amount time or time delay 344 to start from a time when the electronic device detected an initial input from the hand 312 (or, optionally, the user). In some examples, as long as the electronic device 101 detects continued movement of the hand 312 within the threshold amount of time, the electronic device 101 transmits respective data to the mechanical device 324, such as data instructing the mechanical device to move mechanical element 314 in accordance with the movement of hand 312.

In some examples, the data that is transmitted to the mechanical device 324 includes a respective path of motion that directly matches a path of motion of the hand 312. For example, in FIG. 3L, the data that is transmitted to the mechanical device 324 includes a first path of motion 346a that matches the path of motion associated with the hand 312. In some examples, when the hand 312 is used as input, the path of motion as detected by the first electronic device 101 is based on a respective location at which a fingertip of the hand of the user is detected (e.g., a predetermined fulcrum point or key leading point, such as the middle finger of the hand 312). In some examples, the data that is transmitted to the mechanical device 324 includes a respective path of motion that is based on inferred user intent. In some examples, the first electronic device 101 interprets the user's intent, such as the path of motion, based on a comparison between a captured position and orientation of the hand 312 at a first predetermined time frame and a second predetermined time frame, after the first predetermined time frame. In some examples, the first electronic device 101 interprets the user's intent based on contextual information (e.g., container 310 includes other blocks similar to block 308, the container 310 is associated with and/or includes text labeled with a same identifier as the identifier of block 308, and/or the like). In some examples, the first electronic device 101 interprets the user's intent based on historical information (e.g., the first electronic device 101 received a previous request to move a block similar to block 308 from a respective location corresponding to the location of the table 306 to a second respective location corresponding to the location of the container 310). For example, when the first electronic device 101 detects movement of the hand 312 to a location that is within a threshold distance (e.g., 10, 20, 30, 50, 100, 150, 200, or 500 centimeters) of the container 310, the first electronic device 101 optionally infers from the movement information of the hand 312 (or, optionally any of the contextual and/or historical information described herein) that the user intends to place the block 308 within container 310. In some examples, the first electronic device 101 transmits data that includes a second path of motion 346b, different from the first path of motion 346a. The second path of motion 346b includes the mechanical device 324 placing the block 308 within container 310 without requesting or detecting further movement from the hand 312. In some examples, the second path of motion 346b is based the inferred user intent to place block 308 within container 310, as described herein. In some examples, the second path of motion 346b is the shortest distance between a current respective location of the mechanical element 314, as shown in FIG. 3K, to the respective location of the container 310, as shown in FIG. 3L. In some examples, the first electronic device 101 requests confirmation, such as voice input, confirming transmission of data of instructing mechanical device 324 to place the block 308 within container 310.

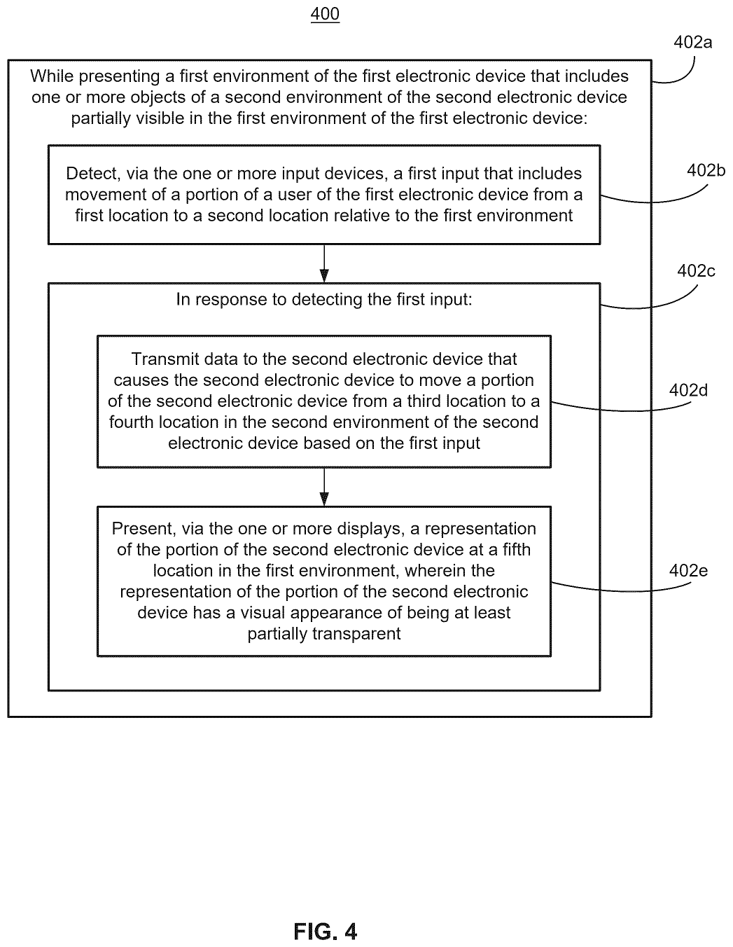

FIG. 4 illustrates a flow diagram illustrating an example process for presenting user interfaces for latency mitigation in the three-dimensional environment according to some examples of the disclosure. In some examples, process 400 begins at a first electronic device in communication with one or more displays, and one or more input devices, and a second electronic device. In some examples, while the first electronic device is presenting (402a) a first environment of the first electronic device and one or more representations of one or more objects of a second environment of the second electronic device (e.g., one of the one or more objects corresponds to a portion of the second electronic device), the first electronic device detects (402b), via the one or more input devices, a first input that includes movement of a portion of a user of the first electronic device from a first location to a second location relative to the first environment. In some examples, in response to detecting the first input (402c), the first electronic device transmits (402d) data to the second electronic device that causes the second electronic device to move the portion of the second electronic device from a first location to a second location in the second environment of the second electronic device based on the first input, and presents (402e), via the one or more displays, the representation of the object corresponding to the portion of the second electronic device at a third location in the first environment. In some examples, the representation of the object corresponding to the portion of the second electronic device has a first visual treatment.

It is understood that process 400 is an example and that more, fewer, or different operations can be performed in the same or in a different order. Additionally, the operations in process 400 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at a first electronic device in communication with one or more displays, and one or more input devices, and a second electronic device: while presenting a first environment of the first electronic device and one or more representations of one or more objects of a second environment of the second electronic device (e.g., one of the one or more objects corresponds to a portion of the second electronic device): detecting, via the one or more input devices, a first input that includes movement of a portion of a user of the first electronic device from a first location to a second location relative to the first environment; and in response to detecting the first input: transmitting data to the second electronic device that causes the second electronic device to move the portion of the second electronic device from a first location to a second location in the second environment of the second electronic device based on the first input; and presenting, via the one or more displays, the representation of the object corresponding to the portion of the second electronic device at a third location in the first environment. In some examples, the representation of the object corresponding to the portion of the second electronic device has a first visual treatment

Additionally or alternatively, in some examples, presenting the representation of the object corresponding to the portion of the second electronic device includes: delaying movement of the representation of the object corresponding to the portion of the second electronic device by an amount relative to movement of the portion of the user of the first electronic device; and in accordance with a determination that a third location of the portion of the second electronic device in the second environment corresponds to a respective location of the portion of the user of the first electronic device in the first environment, ceasing presentation of the representation of the object corresponding to the portion of the second electronic device in the first environment. Additionally or alternatively, in some examples, the movement of the portion of the second electronic device includes a path of motion from a fourth location to the third location in the second environment corresponding to a respective path of motion of the portion of the user of the first electronic device from a fourth location to a fifth location in the first environment.

Additionally or alternatively, in some examples, the movement of the portion of the second electronic device includes a path of motion that is based on inferred user intent. Additionally or alternatively, in some examples, the portion of the user includes a hand of the user; and movement of the portion of the second electronic device includes a path of motion that is based on a respective location at which a fingertip of the hand of the user is detected. Additionally or alternatively, in some examples, the method further comprises: while presenting the representation of the object corresponding to the portion of the second electronic device at the third location in the first environment with the first visual treatment, detecting, via the one or more input devices, a second input that includes movement of the portion of the user of the first electronic device away from the second location relative to the first environment; and in response to detecting the second input: moving the representation of the object corresponding to the portion of the second electronic device in the first environment in accordance with the second input, including: in accordance with a determination that the movement of the representation of the object corresponding to the portion of the second electronic device is to a fourth location in the first environment that is within a threshold distance of a location of the portion of the user of the first electronic device, presenting, via the one or more displays, the representation of the object corresponding to the portion of the second electronic device at the fourth location in the first environment having a first amount of visual treatment; and in accordance with a determination that the movement of the representation of the object corresponding to the portion of the second electronic device is to a fifth location in the first environment that is further than the threshold distance of the location of the portion of the user of the first electronic device, presenting the representation of the object corresponding to the portion of the second electronic device at the fifth location in the first environment having a second amount of visual treatment, different from the first amount of visual treatment.

Additionally or alternatively, in some examples, presenting the representation of the object corresponding to the portion of the second electronic device at the third location in the first environment with the visual treatment includes scaling the representation to a size corresponding to a size of the portion of the user of the first electronic device. Additionally or alternatively, in some examples, in accordance with a determination that movement of the second electronic device is based on a six degree of freedom position and orientation of the second electronic device, the third location at which the representation of the object corresponding to the portion of the second electronic device is presented is based on the six degree of freedom position and orientation of the second electronic device; and in accordance with a determination that movement of the second electronic device is based on a three degree of freedom position and orientation of the second electronic device, the third location at which the representation of the object corresponding to the portion of the second electronic device is presented is based on a translation between the three degree of freedom position and orientation of the second electronic device and the six degree of freedom position and orientation of the second electronic device.

Additionally or alternatively, in some examples, presenting the representation of the object corresponding to the portion of the second electronic device with the visual treatment includes displaying a filling animation of the representation of the object corresponding to the portion of the second electronic device. A rate of the filling animation corresponds to a progress of the movement of the portion of the second electronic device from the first location to the second location in the second environment. Additionally or alternatively, in some examples, the filling animation of the representation of the object corresponding to the portion of the second electronic device includes a wire frame model of the portion of the second electronic device. Additionally or alternatively, in some examples, the method further comprises: while transmitting data to the second electronic device that causes the second electronic device to move the portion of the second electronic device from the first location to the second location in the second environment of the second electronic device based on the first input, determining that one or more criteria are satisfied, including a criterion that is satisfied when the first electronic device fails to detect the movement of the portion of the user of the first electronic device; and in response to determining that the one or more criteria are satisfied, presenting, via the one or more displays, an indication that the first electronic device failed to detect the movement of the portion of the user of the first electronic device.

Additionally or alternatively, in some examples, movement of the portion of the second electronic device includes a path of motion that is determined based on a comparison between a captured position and orientation of the portion of the user of the first electronic device at a first predetermined time and a second predetermined time, after the first predetermined time. Additionally or alternatively, in some examples, prior to transmitting the data to the second electronic device that causes the second electronic device to move the portion of the second electronic device from the first location to the second location in the second environment of the second electronic device based on the first input, transmitting the data to the second electronic device is in accordance with a determination that the first input includes a gaze-based confirmation input from the user of the first electronic device. Additionally or alternatively, in some examples, prior to transmitting the data to the second electronic device that causes the second electronic device to move the portion of the second electronic device from the first location to the second location in the second environment of the second electronic device based on the first input, transmitting the data to the second electronic device is in accordance with a determination that the first input includes a voice confirmation input from the user of the first electronic device.

Additionally or alternatively, in some examples, transmitting the data to the second electronic device that causes the second electronic device to move the portion of the second electronic device from the first location to the second location in the second environment of the second electronic device based on the first input includes transmitting the data to the second electronic device after a time delay without detecting a second input. Additionally or alternatively, in some examples, the method further comprises: while transmitting data to the second electronic device that causes the second electronic device to move the portion of the second electronic device from the first location to the second location in the second environment of the second electronic device based on the first input, detecting, via the one or more input devices, a second input that includes second movement of the portion of the user of the first electronic device relative to the first environment; and in response to detecting the second input: in accordance with a determination that the second input is detected within a threshold amount of time of transmitting the data to the second electronic device, transmitting second data to the second electronic device that causes the second electronic device to move the portion of the second electronic device in the second environment of the second electronic device based on the second input.

Additionally or alternatively, in some examples, the method further comprises: prior to transmitting data to the second electronic device that causes the second electronic device to move the portion of the second electronic device from the first location to the second location in the second environment of the second electronic device based on the first input, determining that one or more criteria are satisfied, including a criterion that is satisfied when detecting the movement of the portion of the user of the first electronic device is above a predetermined velocity; and in response to determining that the one or more criteria are satisfied, presenting, via the one or more displays, an indication that detecting the movement of the portion of the user of the first electronic device is above the predetermined velocity. Additionally or alternatively, in some examples, the method further comprises: in accordance with a determination that the one or more criteria are satisfied, foregoing the transmission of the data until the one or more criteria are not satisfied. Additionally or alternatively, in some examples, the first input that includes movement of portion of the user of the first electronic device from the first location to the second location relative to the first environment includes interaction with a of one of the one or more objects of the second environment of the second electronic device; and causing the second electronic device to move the portion of the second electronic device from the first location to the second location in the second environment of the second electronic device based on the first input includes interaction with the one of the one or more objects of the second environment of the second electronic device. Additionally or alternatively, in some examples, presenting the representation of the object corresponding to the portion of the second electronic device with the first visual treatment includes presenting the representation of the object corresponding to the portion of the second electronic device as being at least partially transparent.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays, one or more input devices, and a second electronic device:
while presenting a first environment of the first electronic device and one or more representations of one or more objects of a second environment of the second electronic device, wherein one of the one or more objects corresponds to a portion of the second electronic device:
detecting, via the one or more input devices, a first input that includes movement of a portion of a user of the first electronic device from a first location to a second location relative to the first environment; and
in response to detecting the first input:
transmitting data to the second electronic device that causes the second electronic device to move the portion of the second electronic device from a first location to a second location in the second environment of the second electronic device based on the first input; and
presenting, via the one or more displays, a representation of the object corresponding to the portion of the second electronic device at a third location in the first environment, wherein the representation of the object corresponding to the portion of the second electronic device has a visual treatment.

2. The method of claim 1, wherein presenting the representation of the object corresponding to the portion of the second electronic device includes:
delaying movement of the representation of the object corresponding to the portion of the second electronic device by an amount relative to movement of the portion of the user of the first electronic device; and
in accordance with a determination that a third location of the portion of the second electronic device in the second environment corresponds to a respective location of the portion of the user of the first electronic device in the first environment, ceasing presentation of the representation of the object corresponding to the portion of the second electronic device in the first environment.

3. The method of claim 1, further comprising:
while presenting the representation of the object corresponding to the portion of the second electronic device at the third location in the first environment with the visual treatment, detecting, via the one or more input devices, a second input that includes movement of the portion of the user of the first electronic device away from the second location relative to the first environment; and
in response to detecting the second input:
moving the representation of the object corresponding to the portion of the second electronic device in the first environment in accordance with the second input, including:
in accordance with a determination that the movement of the representation of the object corresponding to the portion of the second electronic device is to a fourth location in the first environment that is within a threshold distance of a location of the portion of the user of the first electronic device, presenting, via the one or more displays, the representation of the object corresponding to the portion of the second electronic device at the fourth location in the first environment having a first amount of visual treatment; and
in accordance with a determination that the movement of the representation of the object corresponding to the portion of the second electronic device is to a fifth location in the first environment that is further than the threshold distance of the location of the portion of the user of the first electronic device, presenting the representation of the object corresponding to the portion of the second electronic device at the fifth location in the first environment having a second amount of visual treatment, different from the first amount of visual treatment.

4. The method of claim 1, wherein presenting the representation of the object corresponding to the portion of the second electronic device at the third location in the first environment with the visual treatment includes scaling the representation to a size corresponding to a size of the portion of the user of the first electronic device.

5. The method of claim 1, wherein:
in accordance with a determination that movement of the second electronic device is based on a six degree of freedom position and orientation of the second electronic device, the third location at which the representation of the object corresponding to the portion of the second electronic device is presented is based on the six degree of freedom position and orientation of the second electronic device; and
in accordance with a determination that movement of the second electronic device is based on a three degree of freedom position and orientation of the second electronic device, the third location at which the representation of the object corresponding to the portion of the second electronic device is presented is based on a translation between the three degree of freedom position and orientation of the second electronic device and the six degree of freedom position and orientation of the second electronic device.

6. The method of claim 1, wherein presenting the representation of the object corresponding to the portion of the second electronic device with the visual treatment includes displaying a filling animation of the representation of the object corresponding to the portion of the second electronic device, and wherein a rate of the filling animation corresponds to a progress of the movement of the portion of the second electronic device from the first location to the second location in the second environment.

7. The method of claim 1, further comprising:
while transmitting data to the second electronic device that causes the second electronic device to move the portion of the second electronic device from the first location to the second location in the second environment of the second electronic device based on the first input, determining that one or more criteria are satisfied, including a criterion that is satisfied when the first electronic device fails to detect the movement of the portion of the user of the first electronic device; and
in response to determining that the one or more criteria are satisfied, presenting, via the one or more displays, an indication that the first electronic device failed to detect the movement of the portion of the user of the first electronic device.

8. The method of claim 1, wherein movement of the portion of the second electronic device includes a path of motion that is determined based on a comparison between a captured position and orientation of the portion of the user of the first electronic device at a first predetermined time and a second predetermined time, after the first predetermined time.

9. A first electronic device comprising:
one or more processors;
memory; and
one or more programs stored in the memory and configured to be executed by the one or more processors, the one or more programs including instructions for:
while presenting a first environment of the first electronic device and one or more representations of one or more objects of a second environment of a second electronic device, wherein one of the one or more objects corresponds to a portion of the second electronic device: detecting, via one or more input devices, a first input that includes movement of a portion of a user of the first electronic device from a first location to a second location relative to the first environment; and
in response to detecting the first input:
transmitting data to the second electronic device that causes the second electronic device to move the portion of the second electronic device from a first location to a second location in the second environment of the second electronic device based on the first input; and
presenting, via the one or more displays, a representation of the object corresponding to the portion of the second electronic device at a third location in the first environment, wherein the representation of the object corresponding to the portion of the second electronic device has a visual treatment.

10. The first electronic device of claim 9, wherein presenting the representation of the object corresponding to the portion of the second electronic device includes:
delaying movement of the representation of the object corresponding to the portion of the second electronic device by an amount relative to movement of the portion of the user of the first electronic device; and
in accordance with a determination that a third location of the portion of the second electronic device in the second environment corresponds to a respective location of the portion of the user of the first electronic device in the first environment, ceasing presentation of the representation of the object corresponding to the portion of the second electronic device in the first environment.

11. The first electronic device of claim 9, wherein the one or more programs further include instructions for:
while presenting the representation of the object corresponding to the portion of the second electronic device at the third location in the first environment with the visual treatment, detecting, via the one or more input devices, a second input that includes movement of the portion of the user of the first electronic device away from the second location relative to the first environment; and
in response to detecting the second input:
moving the representation of the object corresponding to the portion of the second electronic device in the first environment in accordance with the second input, including:
in accordance with a determination that the movement of the representation of the object corresponding to the portion of the second electronic device is to a fourth location in the first environment that is within a threshold distance of a location of the portion of the user of the first electronic device, presenting, via the one or more displays, the representation of the object corresponding to the portion of the second electronic device at the fourth location in the first environment having a first amount of visual treatment; and
in accordance with a determination that the movement of the representation of the object corresponding to the portion of the second electronic device is to a fifth location in the first environment that is further than the threshold distance of the location of the portion of the user of the first electronic device, presenting the representation of the object corresponding to the portion of the second electronic device at the fifth location in the first environment having a second amount of visual treatment, different from the first amount of visual treatment.

12. The first electronic device of claim 9, wherein presenting the representation of the object corresponding to the portion of the second electronic device at the third location in the first environment with the visual treatment includes scaling the representation to a size corresponding to a size of the portion of the user of the first electronic device.

13. The first electronic device of claim 9, wherein:
in accordance with a determination that movement of the second electronic device is based on a six degree of freedom position and orientation of the second electronic device, the third location at which the representation of the object corresponding to the portion of the second electronic device is presented is based on the six degree of freedom position and orientation of the second electronic device; and
in accordance with a determination that movement of the second electronic device is based on a three degree of freedom position and orientation of the second electronic device, the third location at which the representation of the object corresponding to the portion of the second electronic device is presented is based on a translation between the three degree of freedom position and orientation of the second electronic device and the six degree of freedom position and orientation of the second electronic device.

14. The first electronic device of claim 9, wherein presenting the representation of the object corresponding to the portion of the second electronic device with the visual treatment includes displaying a filling animation of the representation of the object corresponding to the portion of the second electronic device, and wherein a rate of the filling animation corresponds to a progress of the movement of the portion of the second electronic device from the first location to the second location in the second environment.

15. The first electronic device of claim 9, wherein the one or more programs further include instructions for:
while transmitting data to the second electronic device that causes the second electronic device to move the portion of the second electronic device from the first location to the second location in the second environment of the second electronic device based on the first input, determining that one or more criteria are satisfied, including a criterion that is satisfied when the first electronic device fails to detect the movement of the portion of the user of the first electronic device; and
in response to determining that the one or more criteria are satisfied, presenting, via the one or more displays, an indication that the first electronic device failed to detect the movement of the portion of the user of the first electronic device.

16. The first electronic device of claim 9, wherein movement of the portion of the second electronic device includes a path of motion that is determined based on a comparison between a captured position and orientation of the portion of the user of the first electronic device at a first predetermined time and a second predetermined time, after the first predetermined time.

17. A non-transitory computer readable storage medium storing one or more programs, the one or more programs comprising instructions, which when executed by one or more processors of a first electronic device, cause the first electronic device to:
while presenting a first environment of the first electronic device and one or more representations of one or more objects of a second environment of a second electronic device, wherein one of the one or more objects corresponds to a portion of the second electronic device:
detect, via one or more input devices, a first input that includes movement of a portion of a user of the first electronic device from a first location to a second location relative to the first environment; and
in response to detecting the first input:
transmit data to the second electronic device that causes the second electronic device to move the portion of the second electronic device from a first location to a second location in the second environment of the second electronic device based on the first input; and
present, via the one or more displays, a representation of the object corresponding to the portion of the second electronic device at a third location in the first environment, wherein the representation of the object corresponding to the portion of the second electronic device has a visual treatment.

18. The non-transitory computer readable storage medium of claim 17, wherein presenting the representation of the object corresponding to the portion of the second electronic device includes:
delaying movement of the representation of the object corresponding to the portion of the second electronic device by an amount relative to movement of the portion of the user of the first electronic device; and
in accordance with a determination that a third location of the portion of the second electronic device in the second environment corresponds to a respective location of the portion of the user of the first electronic device in the first environment, ceasing presentation of the representation of the object corresponding to the portion of the second electronic device in the first environment.

19. The non-transitory computer readable storage medium of claim 17, wherein the one or more programs further comprise instructions for:
while presenting the representation of the object corresponding to the portion of the second electronic device at the third location in the first environment with the visual treatment, detecting, via the one or more input devices, a second input that includes movement of the portion of the user of the first electronic device away from the second location relative to the first environment; and
in response to detecting the second input:
moving the representation of the object corresponding to the portion of the second electronic device in the first environment in accordance with the second input, including:
in accordance with a determination that the movement of the representation of the object corresponding to the portion of the second electronic device is to a fourth location in the first environment that is within a threshold distance of a location of the portion of the user of the first electronic device, presenting, via the one or more displays, the representation of the object corresponding to the portion of the second electronic device at the fourth location in the first environment having a first amount of visual treatment; and
in accordance with a determination that the movement of the representation of the object corresponding to the portion of the second electronic device is to a fifth location in the first environment that is further than the threshold distance of the location of the portion of the user of the first electronic device, presenting the representation of the object corresponding to the portion of the second electronic device at the fifth location in the first environment having a second amount of visual treatment, different from the first amount of visual treatment.

20. The non-transitory computer readable storage medium of claim 17, wherein presenting the representation of the object corresponding to the portion of the second electronic device at the third location in the first environment with the visual treatment includes scaling the representation to a size corresponding to a size of the portion of the user of the first electronic device.

21. The non-transitory computer readable storage medium of claim 17, wherein:
in accordance with a determination that movement of the second electronic device is based on a six degree of freedom position and orientation of the second electronic device, the third location at which the representation of the object corresponding to the portion of the second electronic device is presented is based on the six degree of freedom position and orientation of the second electronic device; and
in accordance with a determination that movement of the second electronic device is based on a three degree of freedom position and orientation of the second electronic device, the third location at which the representation of the object corresponding to the portion of the second electronic device is presented is based on a translation between the three degree of freedom position and orientation of the second electronic device and the six degree of freedom position and orientation of the second electronic device.

22. The non-transitory computer readable storage medium of claim 17, wherein presenting the representation of the object corresponding to the portion of the second electronic device with the visual treatment includes displaying a filling animation of the representation of the object corresponding to the portion of the second electronic device, and wherein a rate of the filling animation corresponds to a progress of the movement of the portion of the second electronic device from the first location to the second location in the second environment.

23. The non-transitory computer readable storage medium of claim 17, wherein the one or more programs further include instructions for:
while transmitting data to the second electronic device that causes the second electronic device to move the portion of the second electronic device from the first location to the second location in the second environment of the second electronic device based on the first input, determining that one or more criteria are satisfied, including a criterion that is satisfied when the first electronic device fails to detect the movement of the portion of the user of the first electronic device; and
in response to determining that the one or more criteria are satisfied, presenting, via the one or more displays, an indication that the first electronic device failed to detect the movement of the portion of the user of the first electronic device.

24. The non-transitory computer readable storage medium of claim 17, wherein movement of the portion of the second electronic device includes a path of motion that is determined based on a comparison between a captured position and orientation of the portion of the user of the first electronic device at a first predetermined time and a second predetermined time, after the first predetermined time.
